(19) United States
(12) Patent Application Publication
(10) Pub. No.: US 2016/0070937 A1
(43) Pub. Date: Mar. 10, 2016

(54) ELECTRONIC DEVICE AND METHOD THEREOF FOR UNLOCKING DISPLAY OF ELECTRONIC DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: Huan LI, Wuhan (CN)

(21) Appl. No.: 14/576,444

(22) Filed: Dec. 19, 2014

(30) Foreign Application Priority Data
Sep. 5, 2014 (CN) 201410459337.9

(51) Int. Cl. G06F 21/84

(52) U.S. Cl. CPC G06F 21/84

(57) ABSTRACT

A method for unlocking a display of an electronic device includes initializing a process of unlocking the display, detecting a first orientation of the electronic device from a number of predefined orientations, detecting a second orientation of the electronic device from the number of predefined orientations, detecting a third orientation of the electronic device from the number of predefined orientations, detecting a fourth orientation of the electronic device from the number of predefined orientations, and unlocking the display after detecting the first, second, third, and fourth orientations in sequence. The first, second, third, and fourth orientations are detected within a first, second, third, and fourth predetermined time duration, respectively. The first, second, third, and fourth orientations are oriented 90 degrees away from each other along a common rotation direction.

### FIELD

The subject matter herein generally relates to electronic devices, and more particularly to an electronic device and a method thereof for unlocking a display of the electronic device.

### BACKGROUND

A display of an electronic device can be locked to secure the electronic device. Generally, the display of the electronic device can be unlocked, for example, by inputting a code, scanning a fingerprint, or inputting a touch gesture on the display.

### BRIEF DESCRIPTION OF THE DRAWINGS

Implementations of the present technology will now be described, by way of example only, with reference to the attached figures.

FIG. 1 is a block diagram of an exemplary embodiment of an electronic device.

FIG. 2 is a flowchart of an exemplary embodiment of a method of unlocking a display of the electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

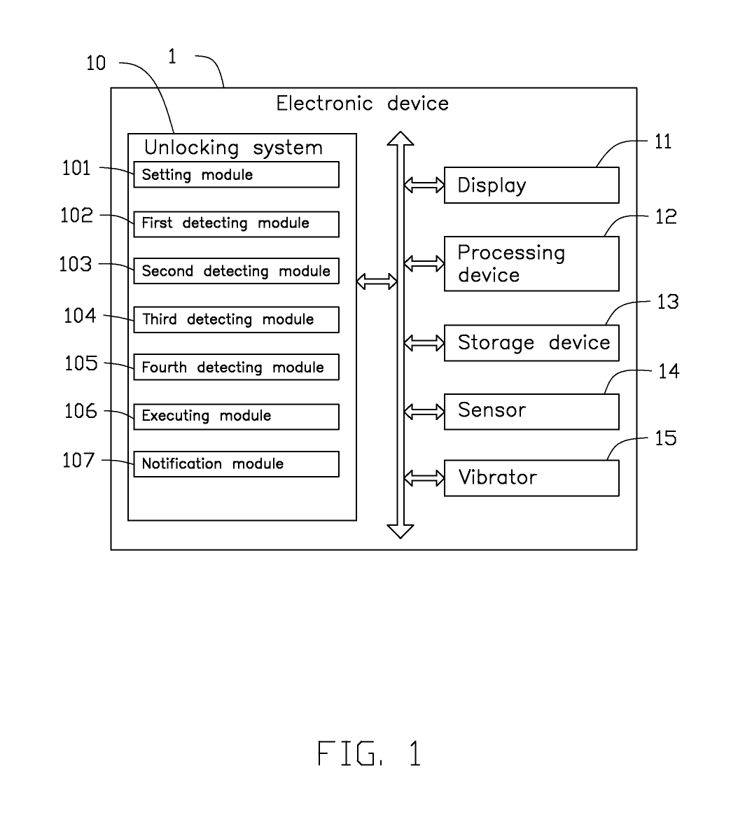

FIG. 1 illustrates an embodiment of an electronic device 1 including a display 11. The display 11 can be unlocked by rotating the electronic device 1. The electronic device 1 can include a processing device 12, a storage device 13, a sensor 14, and a vibrator 15. The sensor 14 can sense a plurality of orientations of the electronic device 1. The display 11 can be unlocked by rotating the electronic device 1 to the plurality of orientations in sequence and meeting a condition of detecting each orientation. The sensor 14 can be an electronic gyroscope, a gravity sensor, an electronic compass, or other suitable orientation detecting device.

The electronic device 1 can further include an unlocking system 10 for unlocking the display 11. The unlocking system 10 can include a plurality of modules, such as a setting module 101, a first detecting module 102, a second detecting module 103, a third detecting module 104, a fourth detecting module 105, an executing module 106, and a notification module 107. The modules 101-107 can include one or more software programs in the form of computerized codes stored in the storage device 13. The computerized codes include instructions executed by the processing device 12 to provide functions for the modules 101-107.

The setting module 101 can define the plurality of orientations of the electronic device. In at least one embodiment, the setting module 101 can define a first orientation, a second orientation, a third orientation, and a fourth orientation. The first, second, third, and fourth orientations can be oriented 90 degrees away from each other along a common rotation direction. For example, the first orientation of the electronic device can be such that the display 11 is face up and parallel to a horizontal plane, the second orientation can be such that the electronic device 1 is rotated 90 degrees along a rotation direction away from the first orientation, the third orientation can be such that the display 11 is face down and parallel to the horizontal plane and rotated 90 degrees along the rotation direction away from the second orientation, and the fourth orientation can be such that the electronic device 1 is rotated 90 degrees along the rotation direction away from the third orientation. A direction of rotating the electronic device 1 from the first orientation to the second orientation can be defined by the setting module 101.

The first detecting module 102 can detect the first orientation of the electronic device 1 after a process of unlocking the display 11 is initialized. The first orientation can be detected within a first predetermined time duration set by the setting module 101. When the first orientation is detected within the first predetermined time duration, the first detecting module 102 controls the vibrator 15 to vibrate in a first vibration mode. The first orientation can be detected within a predetermined angle range set by the setting module 101. In at least one embodiment, the first vibration mode is a short vibration.

The second detecting module 103 can detect the second orientation of the electronic device 1 after the first orientation is detected. The second orientation can be detected within a second predetermined time duration set by the setting module 101. When the second orientation is detected within the second predetermined time duration, the second detecting module 103 controls the vibrator 15 to vibrate in the first vibration mode. The second orientation can be detected within a predetermined angle range set by the setting module 101. In at least one embodiment, after the second orientation is detected, the second detecting module 103 can save information of the second orientation to the storage device 13. The information of the second orientation can include angle information of the second orientation.

The third detecting module 104 can detect the third orientation of the electronic device 1 after the second orientation is detected. The third orientation can be detected within a third predetermined time duration set by the setting module 101. When the third orientation is detected within the third predetermined time duration, the third detecting module 104 controls the vibrator 15 to vibrate in the first vibration mode. The third orientation can be detected within a predetermined angle range set by the setting module 101.

The fourth detecting module 105 can detect the fourth orientation of the electronic device 1 after the third orientation is detected. The fourth orientation can be detected within a fourth predetermined time duration set by the setting module 101. When the fourth orientation is detected within the fourth predetermined time duration, the fourth detecting module 105 controls the vibrator 15 to vibrate in the first vibration mode. The fourth orientation can be detected within a predetermined angle range set by the setting module 101. In at least one embodiment, the fourth detecting module 105 detects the fourth orientation of the electronic device 1 by calculating an angle change in orientation according to the information of the second orientation saved in the storage device 13.

In at least one embodiment, the first, second, third, and fourth predetermined time durations can be the same. In other embodiments, the first, second, third, and fourth predetermined time durations can be different.

The executing module 106 can initialize the process of unlocking the display 11, and unlock the display 11 after the first, second, third, and fourth orientations of the electronic device 1 are detected in sequence.

The notification module 107 can control the vibrator 15 to vibrate in a second vibration mode when any of the second, third, and fourth orientations is not detected within the second, third, or fourth time durations, respectively. When the vibrator 15 is controlled to vibrate in the second vibration mode, the process of unlocking the display 11 can be returned to detecting the first orientation within the first predetermined time duration.

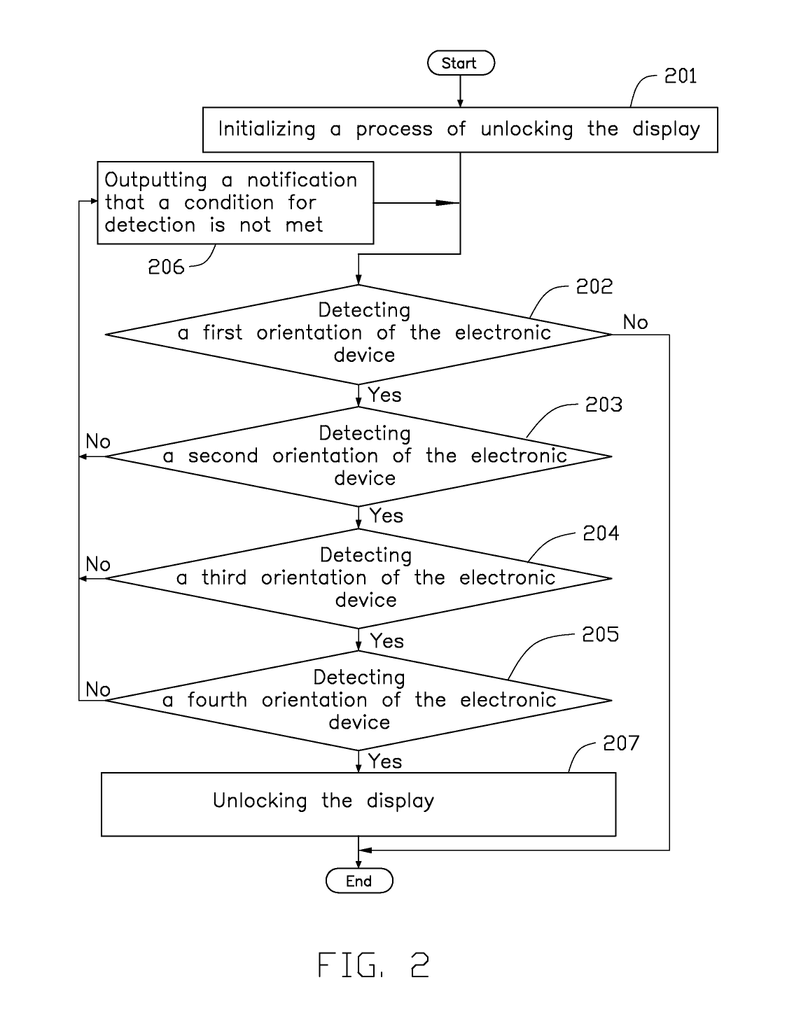

FIG. 2 illustrates a flowchart of an exemplary method for unlocking a display of an electronic device. The example method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks may be added or fewer blocks may be utilized, without departing from this disclosure. The example method can begin at block 201.

At block 201, a process of unlocking the display can be initialized.

At block 202, a first orientation of the electronic device can be detected. The first orientation can be detected within a first predetermined time duration. When the first orientation is detected within the first predetermined time duration, the electronic device can be controlled to vibrate in a first vibration mode, and block 203 is implemented. If the first orientation is not detected within the first predetermined time duration, block 207 is implemented. The first orientation can be detected within a predetermined angle range. In at least one embodiment, the first vibration mode is a short vibration, and the first orientation of the electronic device is such that the display is face up and parallel to a horizontal plane.

At block 203, a second orientation of the electronic device can be detected. The second orientation can be detected within a second predetermined time duration. When the second orientation is detected within the second predetermined time duration, the electronic device can be controlled to vibrate in the first vibration mode, and block 204 is implemented. If the second orientation is not detected within the second predetermined time duration, block 207 is implemented. The second orientation can be detected within a predetermined angle range. In at least one embodiment, the second orientation of the electronic device is such that the electronic device is rotated 90 degrees along a rotation direction away from the first orientation.

At block 204, a third orientation of the electronic device can be detected. The third orientation can be detected within a third predetermined time duration. When the third orientation is detected within the third predetermined time duration, the electronic device can be controlled to vibrate in the first vibration mode, and block 205 is implemented. If the third orientation is not detected within the third predetermined time duration, block 207 is implemented. The third orientation can be detected within a predetermined angle range. In at least one embodiment, the third orientation of the electronic device is such that the display is face down and parallel to the horizontal plane and rotated 90 degrees along the rotation direction away from the second orientation.

At block 205, a fourth orientation of the electronic device can be detected. The fourth orientation can be detected within a fourth predetermined time duration. When the fourth orientation is detected within the fourth predetermined time duration, the electronic device can be controlled to vibrate in the first vibration mode, and block 206 is implemented. If the fourth orientation is not detected within the fourth predetermined time duration, block 207 is implemented. The fourth orientation can be detected within a predetermined angle range. In at least one embodiment, the fourth orientation of the electronic device is such that the electronic device is rotated 90 degrees along the rotation direction away from the third orientation.

At block 206, the display of the electronic device can be unlocked.

At block 207, the electronic device can be controlled to vibrate in a second mode to notify that the corresponding orientation of the electronic device was not detected within the corresponding predetermined time duration, and block 402 can be implemented.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A method for unlocking a display of an electronic device, the method comprising:
initializing a process of unlocking the display;
detecting a first orientation of the electronic device from a plurality of predefined orientations of the electronic device;
detecting a second orientation of the electronic device from the plurality of predefined orientations of the electronic device;
detecting a third orientation of the electronic device from the plurality of predefined orientations of the electronic device;
detecting a fourth orientation of the electronic device from the plurality of predefined orientations of the electronic device; and
unlocking the display of the electronic device after detecting the first, second, third, and fourth orientations of the electronic device;
wherein the first, second, third, and fourth orientations of the electronic device are detected in sequence.

2. The method as in claim 1, wherein the first, second, third, and fourth orientations are 90 degrees apart from each other along a common rotation direction of the electronic device.

3. The method as in claim 1, wherein:
the electronic device is oriented in the second orientation by being rotated 90 degrees from the first orientation;
the electronic device is oriented in the third orientation by being rotated 90 degrees from the second orientation; and
the electronic device is oriented in the fourth orientation by being rotated 90 degrees from the third orientation.

4. The method as in claim 3, wherein a rotation direction from the first orientation to the second orientation, a rotation direction from the second orientation to the third orientation, and a rotation direction from the third orientation to the fourth orientation are the same.

5. The method as in claim 3, wherein:
the rotation direction of the electronic device from the first orientation to the second orientation is predefined;
the rotation direction of the electronic device from the second orientation to the third orientation is the same as the rotation direction of the electronic device from the first orientation to the second orientation; and
the rotation direction of the electronic device from the third orientation to the fourth orientation is the same as the rotation direction of the electronic device from the second orientation to the third orientation.

6. The method as in claim 3, wherein:
when the electronic device is in the first and third orientations, the display of the electronic device is parallel with a horizontal plane; and
when the electronic device is in the second and fourth orientations, the display of the electronic device is perpendicular to the horizontal plane.

7. The method as in claim 1, wherein:
the electronic device vibrates in a first vibration mode when the first orientation of the electronic device is detected within a first predetermined time duration;
the electronic device vibrates in the first vibration mode when the second orientation of the electronic device is detected within a second predetermined time duration after the first orientation is detected;
the electronic device vibrates in the first vibration mode when the third orientation of the electronic device is detected within a third predetermined time duration after the second orientation is detected; and
the electronic device vibrates in the first vibration mode when the fourth orientation of the electronic device is detected within a fourth predetermined time duration after the third orientation is detected.

8. The method as in claim 7, wherein the first orientation, the second orientation, the third orientation, and the fourth orientation are each detected within a predefined angle range.

9. The method as in claim 7, wherein:
the electronic device vibrates in a second vibration mode when the second orientation of the electronic device is not detected within the second predetermined time duration, when the third orientation of the electronic device is not detected within the third predetermined time duration, or when the fourth orientation of the electronic device is not detected within the fourth predetermined time duration; and
the unlocking process of the electronic device is returned to detecting the first orientation within the first predetermined time duration.

10. The method as in claim 7, wherein the first vibration mode is a short vibration.

11. The method as in claim 9, wherein the second vibration mode is a long vibration.

12. An electronic device comprising:
a display;
a sensor configured to sense a plurality of orientations of the electronic device;
a vibrator configured to make the electronic device vibrate in one of two vibration modes during a process of unlocking the display;
a storage device configured to store instructions of a plurality of modules of an unlocking system; and
a processor configured to execute the plurality of instructions of the plurality of modules of the unlocking system, the plurality of modules comprising:
a setting module configured to define the plurality of orientations of the electronic device;
a first detecting module configured to detect a first orientation of the plurality of orientations of the electronic device sensed by the sensor;
a second detecting module configured to detect a second orientation of the plurality of orientations of the electronic device sensed by the sensor;
a third detecting module configured to detect a third orientation of the plurality of orientations of the electronic device sensed by the sensor;
a fourth detecting module configured to detect a fourth orientation of the plurality of orientations of the electronic device sensed by the sensor;
an executing module configured to unlock the display of the electronic device after the first, second, third, and fourth orientations of the electronic device are detected in sequence; and
a notification module configured to output a notification when a condition for detection of one of the plurality of orientations is not met.

13. The electronic device as in claim 12, wherein the first detecting module, the second detecting module, the third detecting module, and the fourth detecting module control the vibrator to vibrate in a first vibration mode when the conditions for detection of the first orientation, the second orientation, the third orientation, and the fourth orientation are met, respectively.

14. The electronic device as in claim 12, wherein the notification module outputs the notification by controlling the vibration module to vibrate in a second vibration mode.

15. The electronic device as in claim 12, wherein:
the first, second, third, and fourth orientations are oriented 90 degrees away from each other along a common rotation direction of the electronic device.

16. The electronic device as in claim 15, wherein a rotation direction of the electronic device from the first orientation to the second orientation is predefined;
a rotation direction of the electronic device from the second orientation to the third orientation is the same as the rotation direction of the electronic device from the first orientation to the second orientation; and
a rotation direction of the electronic device from the third orientation to the fourth orientation is the same as the rotation direction of the electronic device from the second orientation to the third orientation.

17. The electronic device as in claim 15, wherein the first, second, third, and fourth orientations of the electronic device are each within a predetermine angle range set by the setting module.

18. The electronic device as in claim 13, wherein:
the condition for detection of the first orientation is met when the first detecting module detects the first orientation of the electronic device within a first predetermined time duration after a process of unlocking the display is initialized;
the condition for detection of the second orientation is met when the second detecting module detects the second orientation of the electronic device within a second predetermined time duration after the first orientation is detected;
the condition for detection of the third orientation is met when the third detecting module detects the third orientation of the electronic device within a third predetermined time duration after the second orientation is detected; and
the condition for detection of the fourth orientation is met when the fourth detecting module detects the fourth orientation of the electronic device within a fourth predetermined time duration after the third orientation is detected.

19. The electronic device as in claim 17, wherein:
after the condition of the second detecting module detecting the second orientation of the electronic device is met, the second detecting module saves information of the second orientation to the storage device, the information comprising angle information of the electronic device relative to the first electronic device; and
the fourth detecting module detects the fourth orientation of the electronic device by calculating an angle change in orientation according to the information of the second orientation saved in the storage device.
